(19) United States
(12) Patent Application Publication
(10) Pub. No.: US 2026/0318331 A1
(43) Pub. Date: Oct. 15, 2026

(54) SHAFT LOCKING DEVICE

(71) Applicant: Liftwave, Inc. dba Rise Robotics, Somerville, MA (US)

(72) Inventor: Blake Sessions, Boston, MA (US)

(21) Appl. No.: 19/646,804

(22) Filed: Apr. 14, 2026

Related U.S. Application Data
(60) Provisional application No. 63/789,049, filed on Apr. 15, 2025.

(51) Int. Cl. F15B 15/26; F16D 13/20

(52) U.S. Cl. CPC F15B 15/264; F16D 13/20

(57) ABSTRACT

This disclosure describes systems, apparatus, and a method for locking devices to allow or prohibit movement of a shaft as desired. This can include a locking device comprising: a fixed section comprising one or more first mating features configured to engage with one or more second features in a housing; a rotatable section comprising one or more external threads configured to engage with one or more internal threads of the housing; and a shift mechanism configured to shift axial load across the locking device between a low friction surface and a high friction surface.

### CROSS REFERENCE TO RELATED APPLICATIONS

This application claims priority to U.S. Provisional Application No. 63/789,049, filed Apr. 15, 2025, the entire content of which application is hereby incorporated by references in its entirety.

### TECHNICAL FIELD

This disclosure generally relates to locking devices to allow or prohibit movement of a shaft as desired.

### BACKGROUND

Linear actuators often include shafts that translate axially to deliver force or movement. Linear actuators can be used in safety critical high force applications where a sudden power loss, loss of pressure, or loss of position control could have negative results. As such, locking devices can be used to ensure hold capability during power loss or overload conditions.

### SUMMARY

In general, the disclosure involves systems and methods for locking devices to allow or prohibit movement of a shaft as desired. This disclosure describes a locking device comprising: a fixed section comprising one or more first mating features configured to engage with one or more second mating features in a housing; a rotatable section comprising one or more external threads configured to engage with one or more internal threads of the housing; and a shift mechanism configured to shift axial load across the locking device between a low friction surface and a high friction surface.

This disclosure optionally includes one or more of the following features.

In some instances, the one or more first mating features are ridges or keyways, and wherein the one or more second mating features are keyways or ridges.

In some instances, when a ratio of axial load supplied to the low friction surface compared to axial load supplied to the high friction surface is greater than a predetermined amount, the locking device is back-drivable along the internal threads, and wherein when the ratio of axial load is below the predetermined amount, the locking device is non-back-drivable along the internal threads.

In some instances, the rotatable section is configured to rotate about an axis, and wherein the axial load is along the axis.

In some instances, the high friction surface is a brake, and wherein the low friction surface is supported by a thrust bearing.

In some instances, the fixed section is rigidly connected to an actuator shaft of a linear actuator.

In some instances, an actuating mechanism of the linear actuator is configured to act on the fixed section by applying force to the fixed section along an axis defined by the actuator shaft.

In some instances, an actuating mechanism of the linear actuator is configured to act on the actuator shaft by applying force along an axis defined by the actuator shaft.

In some instances, the shift mechanism comprises a rotatable thrust driver and a translatable thrust driver that form a thrust driver pair, and wherein the thrust driver pair is configured to elongate when the rotatable thrust driver is rotated.

In some instances, the rotatable thrust driver and the translatable thrust driver comprise oil ports configured to permit passage of oil through the thrust driver pair.

In some instances, the one or more second mating features comprise three keyways, and wherein the one or more first mating features comprise three ridges.

In some instances, the external threads comprise multiple leader threads and multiple follower threads, and wherein the follower threads are configured to engage the internal threads of the housing in response to a failure of one or more of the leader threads.

In some instances, a lead angle of the external threads is at least six degrees.

This disclosure further describes a method including: actuating a shift mechanism to cause a transfer of axial load across a locking device affixed to the shaft, the transfer of axial load occurring between a low friction surface and a high friction surface, wherein as the axial load is shifted to the low friction surface from the high friction surface, the locking device becomes back-drivable along internal threads of the housing, and wherein when the axial load is shifted from the low friction surface to the high friction surface the locking device becomes non-back-drivable along the internal threads.

In some instances, wherein actuating the shift mechanism comprises rotating a thrust driver to cause a riser assembly to change an internal dimension of the locking device.

In some instances, the method includes back-driving the locking device through the housing when the axial load is applied to the low friction surface.

In some instances, the low friction surface is supported by a thrust bearing, and wherein the high friction surface is a brake surface.

Additionally, a linear actuator system is disclosed comprising: an actuator shaft coupled to a locking device; an actuator mechanism coupled to the locking device and configured to transfer force to the actuator shaft to cause the actuator shaft to translate along an axis defined by the actuator shaft; the locking device comprising: a rotatable section comprising one or more external threads configured to engage with one or more internal threads of a housing; and a shift mechanism configured to shift axial load across the locking device between a low friction surface and a high friction surface, wherein when the axial load is applied to the low friction surface, the locking device is back-drivable along the internal threads, and wherein when the axial load is applied to the high friction surface the locking device is non-back-drivable along the internal threads.

In some instances, the locking device comprises: a fixed section comprising one or more ridges configured to engage with one or more keyways in the housing.

In some instances, the housing comprises three keyways, and wherein the fixed section comprises three ridges.

In some instances, the high friction surface is a brake, and wherein the low friction surface is supported by a thrust bearing.

In some instances, the shift mechanism comprises a rotatable thrust driver and a translatable thrust driver that form a thrust driver pair, and wherein the thrust driver pair is configured to elongate when the rotatable thrust driver is rotated.

In some instances, the external threads comprise multiple leader threads and multiple follower threads, and wherein the follower threads are configured to engage the internal threads of the housing in response to a failure of one or more of the leader threads.

In some instances, a lead angle of the external threads is at least six degrees.

In general, disclosed herein is a locking device that acts as a rotating nut inside of a housing which can be selectable back-drivable or non-back-drivable. When the device is in a back-drivable configuration, it can translate and rotate with little axial force applied. When the device is in a non-back-drivable configuration, it “seizes” or “binds” within the housing, and is able to withstand large axial loads without moving.

The disclosed solution can be advantageous because the disclosed system can rely on purely independent power sources to operate. For example, a battery powered servo or electric system can enable operation of the locking device without external power. Further the disclosed locking device compactly fits within the footprint of many linear actuators, and therefore does not require any additional external space, wiring, piping, or external valves to operate. Further the disclosed locking device operates on entirely redundant mechanical components that are separate from the principal power handling components within the actuator. That is, if the mechanisms associated with the actuator (e.g., hydraulics, belt system, power supply, screw drive, etc.) fail, the locking mechanism can remain operational and maintain the actuator's shaft position. In some instances, the locking device can be configured to require a constant input torque provided by electrical power such that in a loss of power situation, the locking device can automatically and mechanically lock, preventing any un-commanded movement during the power loss event. Another advantage is that by using a braking surface as opposed to a spline, gear, or other mechanism, the device can be smoothly “unlocked” or shifted even when under load, by gradually adjusting the support condition from braked, to brake and bearing, to just bearing. In some implementations, the disclosed locking device can be engaged during normal operations to “stiffen” an actuator. Hydraulic and electric actuators can have some natural damping such that they absorb energy transmitted through them while in a static condition. By engaging the disclosed mechanical lock, the actuator can more efficiently transmit force while reducing total compliance. For example, a jackhammer or other impulse based device that is positioned on the end of a robotic arm may require the actuators in that arm to be very rigid when not in motion in order to maximize energy delivered to the target material by the impulse. The disclosed locking device can be used to improve the rigidity of an actuator.

In some instances, the disclosed locking device may also be used to operate the linear actuator dynamically, for example in an emergency situation involving a payload held in an elevated configuration. If the primary load bearing components have failed, the control shaft of the locking device may be modulated such that sliding action occurs at the working surfaces of the brake, resulting in a slow and controlled movement that can safely return the physically elevated or otherwise energized payload to a low energy state.

Locking devices may convey further benefits to the linear actuator, such as improving the axial stiffness of the actuator while in a locked condition, shielding the actuator's power handling components from extreme axial impact forces, and reducing wear and tear on the actuator's power handling components arising from repeated static loading cycles.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

To describe technical solutions in the implementations of the present specification more clearly, the following briefly describes the accompanying drawings useful for describing those implementations. The accompanying drawings in the following descriptions merely show some implementations of the present specification.

FIG. 1A illustrates a linear actuator with a locking device installed.

FIG. 1B illustrates a partial cutaway view of a linear actuator in FIG. 1A with a locking device installed.

FIG. 2 is a perspective view of the locking device of FIG. 1.

FIG. 3 is an end view showing some internal structure of an internally threaded housing.

FIG. 4 is a side view of external threads on a portion of the locking device as described above.

FIG. 5 is a bar graph illustrating various operating conditions for a locking device.

FIG. 6 is a cutaway view illustrating some internal components of a locking device.

FIG. 7 is a perspective cross-sectional view showing force paths within a locking device.

FIGS. 8A-8C illustrate a simplified schematic diagram showing a shifting operation for a locking device.

FIG. 9 illustrates an example compact actuator for shifting a locking device.

FIG. 10 illustrates a bushing for a compact actuator.

FIG. 11 illustrates a diagram showing example load across a locking device in various conditions.

Like reference numbers and designations in the various drawings indicate like elements.

### DETAILED DESCRIPTION

This disclosure describes a locking device that acts as a rotating nut inside of a housing which can be selectable to be back-drivable or non-back-drivable. When the device is in a back-drivable configuration, the device can translate and rotate with little axial force applied. When the device is in a non-back-drivable configuration, it “seizes” or “binds” within the housing and is able to withstand large axial loads without moving. Because additional axial force increases both the thread friction and the brake friction, the holding force of the locking device is self-intensifying and will not release until either axial force is decreased, the brake friction is decreased (e.g., by shifting some of the axial force off the brake and onto a bearing) or a mechanical failure occurs.

Whether the locking device is back-drivable is determined by the manner in which it is supported. If the rotating section of the locking device is supported on a low friction thrust bearing, then the drive torque caused by the threads (due to the thread angle) in response to an axial force is greater than the maximum rotational frictional torque on the device, and it can move. When the locking device is supported on a high-friction brake surface, that same drive torque caused by the threads does not exceed the frictional torque generated by the combination of the threads and the brake surface, and the locking device binds and will not move regardless of axial load applied.

To help a person skilled in the art better understand the technical solutions in the present specification, the following clearly and comprehensively describes the technical solutions in the implementations of the present specification with reference to the accompanying drawings. The described implementations are merely some rather than all the implementations of the present specification. All other implementations obtained by a person of ordinary skill in the art based on one or more implementations of the present specification without creative efforts shall fall within the protection scope of the implementations of the present specification.

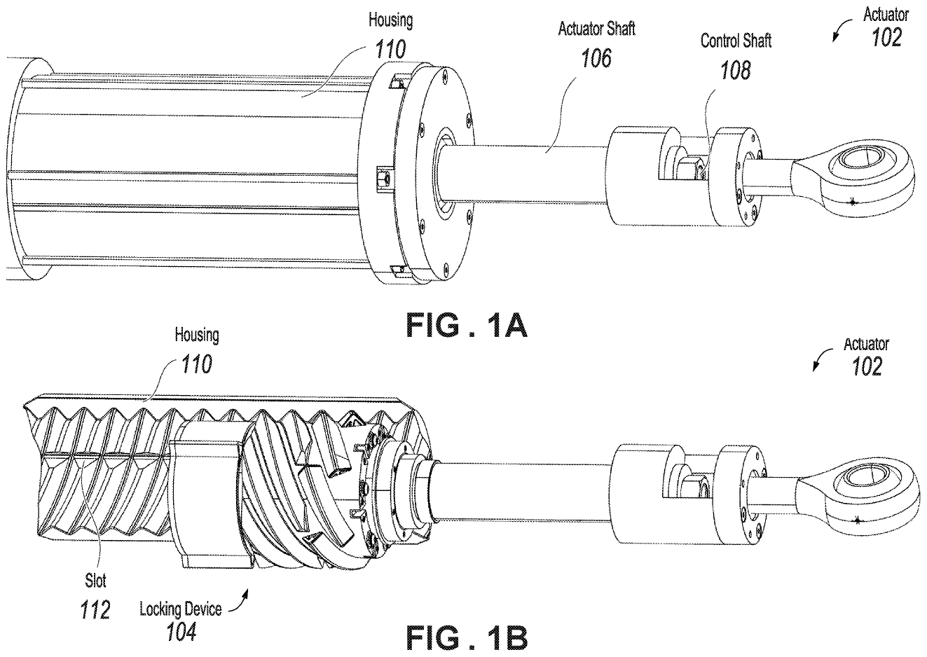

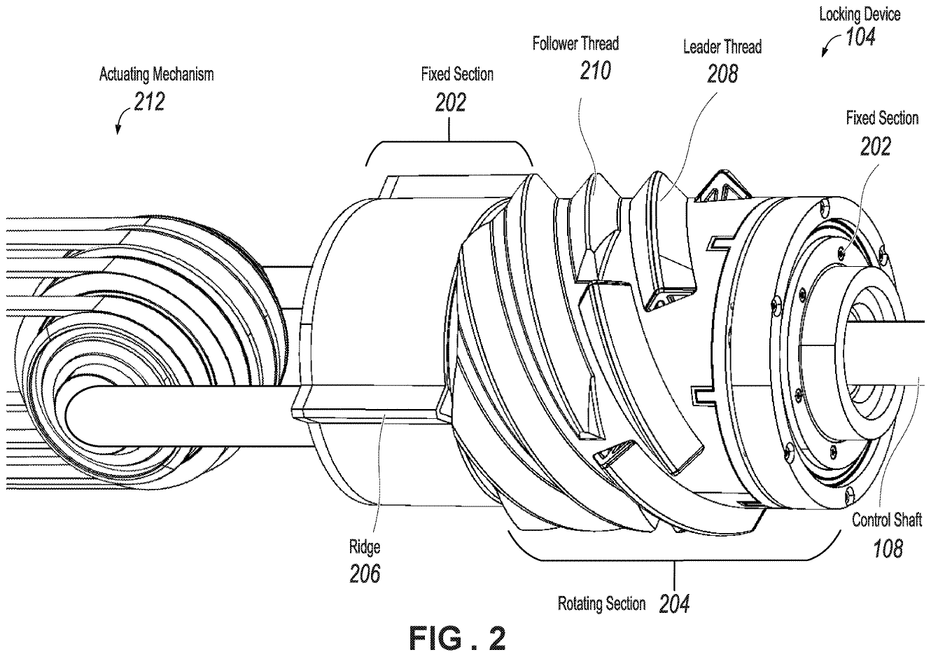

FIG. 1A illustrates a linear actuator 102 with a locking device 104 (shown in FIG. 1B) installed. The locking device 104 is affixed to an actuator shaft 106 that during normal operation translates into or out of housing 110. In some implementations, the actuator 102 can be a hydraulic actuator. In certain implementations, the actuator 102 is a belt-driven actuator or other electric actuator.

A control shaft 108 can be nested internally to the actuator shaft 106 and can control the condition of the locking device (e.g., back-drivable or non-back-drivable) by altering the rotation of the control shaft by manual or electric means. While illustrated as nested in the actuator shaft 106 to provide an external control to the locking device 104, other configurations are possible. For example, the control shaft 108 can be positioned in different locations. For example, it can be internal to housing 110, or internal to the locking device itself. As illustrated, the control shaft 108 includes a hex surface on the end that enables manual operation (e.g., manual release or locking with a hex wrench).

FIG. 1B illustrates a partial cutaway diagram of the linear actuator 102 with the locking device 104 installed. As shown, the housing 110 has internal threads into which the locking device 104 seats. The locking device, when unlocked, can rotate within the threads and be back-driven within the housing 110 by the actuator shaft 106, or an actuating mechanism (for example actuating mechanism 212 illustrated below with respect to FIG. 2) of the linear actuator. The internal threads in the housing 110 can include a slot 112 or keyway, which the locking device 104 indexes against to ensure non-rotating portions of the locking device 104 remain oriented correctly and can provide sufficient reaction torque to enable the locking device 104 to bind or lock.

FIG. 2 is a perspective view of the locking device 104. The illustrated locking device 104 includes a fixed section 202, which does not rotate but only translates with respect to the housing 110, and a rotating section 204 that rotates around the fixed section 202 when the locking device 104 translates. The fixed section 202 can include one or more ridges 206, with the illustrated example including three ridges 206. The ridges 206 can engage with a keyway or slot (e.g., slot 112 of FIG. 1B) and prevent rotation of the fixed section 202 relative to the housing 110.

An example actuating mechanism 212 is illustrated connected to the fixed section 202. In the illustrated example, the actuating mechanism is a pulley stack, where the linear actuator is a belt-operated, block and tackle type actuator. In some implementations, the actuating mechanism 212 is a hydraulic cylinder, or an electric type actuator. Any suitable actuating mechanism 212 that is sufficient to exert axial force on the fixed section 202 of the locking device 104, thereby translating the locking device 104 (and corresponding actuator shaft 106 as shown in FIG. 1) is considered within the scope of this disclosure.

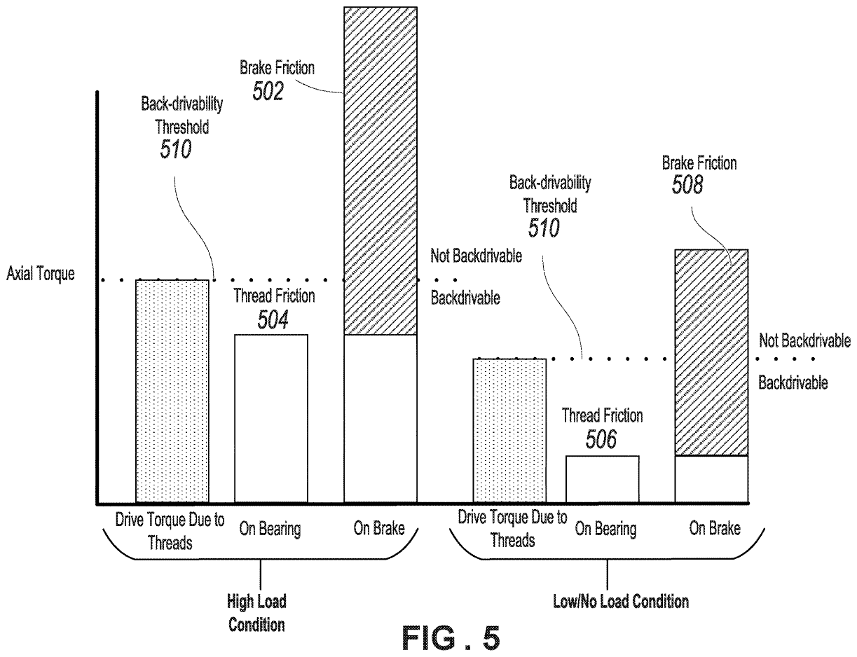

The control shaft 108 can be rotated in order to shift the modes of the locking device 104. As described in more detail below with respect to FIGS. 5-9, rotating the control shaft 108 can introduce significant friction between the rotating section 204 and the fixed section 202 rendering the locking device 104 non-back-drivable or “locked.”

Referring again to FIG. 2, the rotating section 204 includes a set of leader threads 208 and a set of follower threads 210. In some implementations, the leader threads 208 are formed of a synthetic or tribologically favorable material such as polyether-ether-ketone (PEEK), polyimide (PI), oil-impregnated bronze, high-density polyethylene (HDPE), polycarbonate, plastic, or other material. The leader threads 208 can be formed of self-lubricating material with low friction characteristics. Additionally, the leader threads 208 can be slightly larger than the follower threads 210, ensuring that during normal operating conditions, the follower threads 210 do not contact the internal threading of the housing. While illustrated as triangular threads, the leader threads 208 can have other profiles. For example, the leader threads 208 can be trapezoidal, square, rectangular, round, buttress shaped, or have other thread profiles. Under extreme overload conditions, or conditions where one or more leader threads 208 have failed or have worn substantially over their service life, the follower threads 210 can engage the housing and prevent the locking device 104 from translating within the housing without rotating. In some implementations, the follower threads 210 are metal (e.g., aluminum or steel) and are formed as an integral component of an outer shell of the rotating section 204. While illustrated as trapezoidal threads, the follower threads 210 can have other profiles. For example, the follower threads can be buttress threads, round threads, square threads, or other suitable profiles.

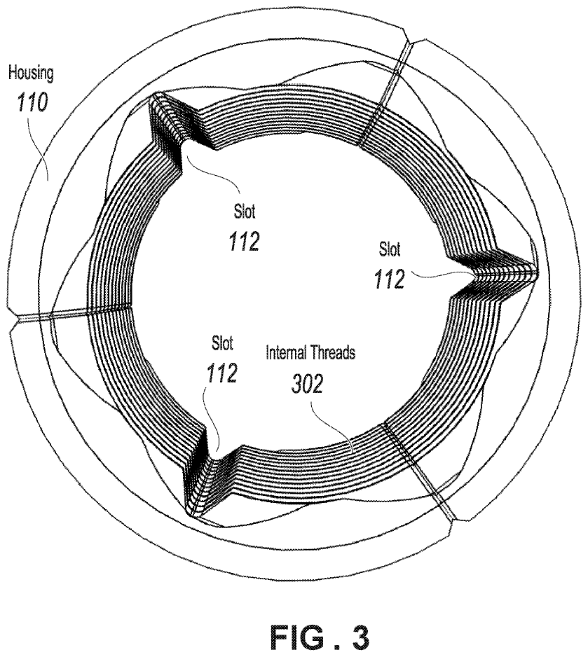

FIG. 3 is an end view showing some internal structure of the internally threaded housing 110. The illustrated internal threads 302 are what engage with the rotating section 204 of the locking device 104. In the illustrated example, the housing 110 includes three slots 112 that engage with ridges 206 on the locking device 104 and prevent the fixed section 202 of the locking device from rotating relative to the housing 110. It should be noted that greater or fewer slots 112 are possible. For example, the housing can alternatively include one slot, two slots, four slots, or more than four slots. In general, three slots 112 can be advantageous in that can increase the distribution of reaction torque across the most area while limiting the weakening of the structural integrity of housing 110.

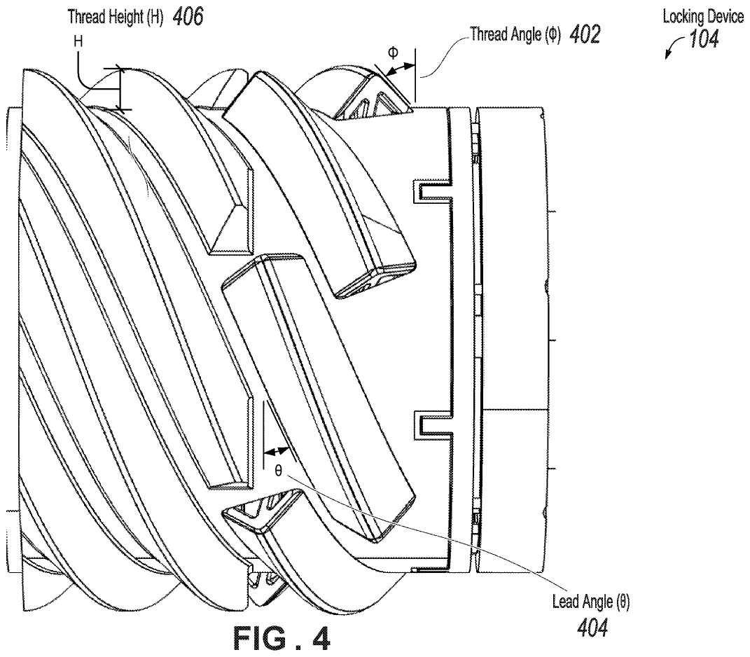

FIG. 4 is a side view of external threads on a portion of the locking device 104. FIG. 4 shows the threads with a height H 406, and a thread angle @ 402. Further the threads are arranged on the locking device with a lead angle θ 404. These parameters are useful for calculating whether the threaded locking device will be back-drivable. In some implementations, for a rotatably supported lead screw, a lead angle of greater than six degrees will enable back-driving of the lead screw depending on the materials used and thread geometry. Whether a threaded device will be back-drivable (i.e., whether it will be able to readily travel along a threaded path, rotating, in response to externally applied linear force) is determined by the relationship between the torque induced to rotate the device and the friction resisting that rotation. In other words, if the drive torque is greater than the maximum friction torque, travel will be induced:

τ_{Drive}>τ_{Friction} (1)

Alternatively, if the friction torque limit at the maximum coefficient of friction is greater than the drive torque, the threaded device will not travel:

τ_{Drive}<τ_{FrictionMAX} (2)

The drive torque is a function of the lead angle (θ), thread angle (Φ), normal force on the threads (N), and the average thread radius (R₁). This can be represented as:

τ_{Drive}=R₁Nsin(θ)cos(Φ) (3)

Similarly, the torque due to thread friction is a function of lead angle (θ), thread normal force (N) or the force that is exerted along the normal to the thread surface, the average thread radius (R₁) and the friction coefficient (μ₁) between the internal threads and the external threads. An additional friction component (brake friction) can be added which is a function of the average brake radius (R₂), the lead angle (θ), thread angle (Φ), normal force (N), the friction coefficient (μ₂) between the brake contacting surfaces, and the angle of the brake interface (β). Therefore,

τ_{Friction}=Friction_{Threads}+Friction_{Brake} (4)

$${τ}_{F riction} = {R}_{1} N {μ}_{1} cos ( θ ) + \frac{{R}_{2} N {μ}_{2} cos ( θ ) cos ( Φ )}{cos ( β )} \qquad ( 5 )$$

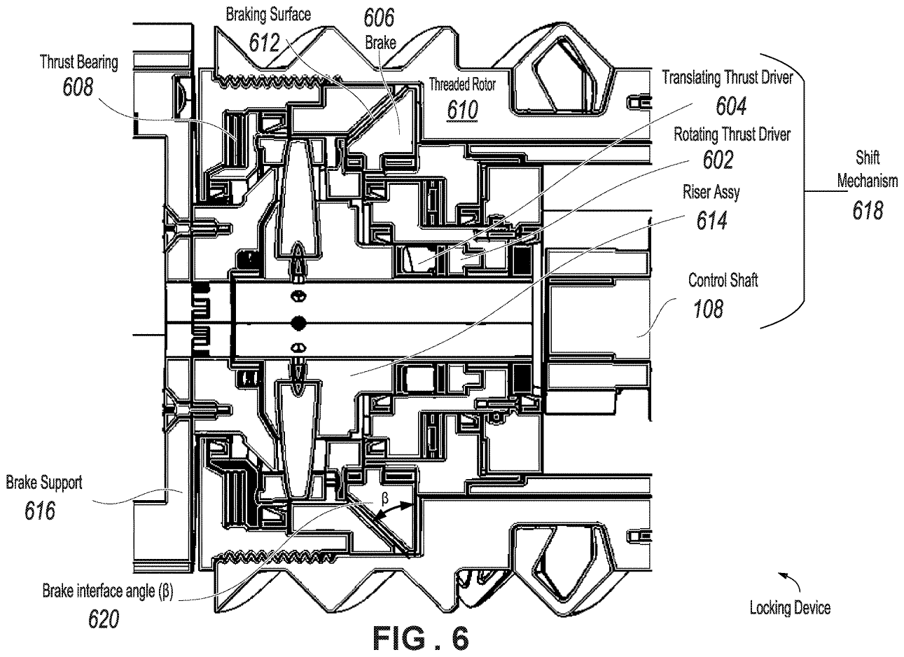

The angle of the brake interface (β) is illustrated below in FIG. 6 as brake interface angle 620.

Therefore, if the magnitude of the brake friction is large enough that the following inequality is satisfied, then the locking device will be locked, and not back-drivable:

$${R}_{1} N sin ( θ ) cos ( Φ ) < {R}_{1} N {μ}_{1} cos ( θ ) + \frac{{R}_{2} N {μ}_{2} cos ( θ ) cos ( Φ )}{cos ( β )} \qquad ( 6 )$$

Otherwise, if the brake friction term is reduced, and inequality (6) above is not satisfied, the locking device will be back-drivable. One feature to note about this equation is that as normal force (e.g., axial load) increases on the device, both the thread friction and the brake friction also increase, and the inequality is not altered. This means that the device will “bind”: it has a self-intensifying locking force as axial load is increased.

FIG. 5 is a bar graph illustrating various operating conditions for a locking device. The Y-axis of the graph represents the torques acting on the threaded rotor. When the maximum frictional torque exceeds the drive torque, the locking device will become non-back-drivable. When the drive torque exceeds the maximum frictional torque, the locking device will back-drive.

As illustrated, in a high load condition, with large normal forces, thread friction 504 alone can be insufficient to prevent back-driving. The locking device is free to move when it is axially supported by a bearing and thread friction is the only significant torque countering the drive torque from thread contact. However, when the rotation section 204 is supported by a non-rotating brake that provides relatively high friction compared to the bearing, brake friction 502 is added to thread friction 504, and the device crosses above the back-drivability threshold 510 and locks in place.

When the locking device is under low load or no load, both thread friction and brake friction are reduced, as shown by the thread friction 506 and the brake friction 508 depicted in FIG. 5. However, the difference in total friction when on the brake as compared to when on the bearing is still sufficient to cross the back-drivability threshold 510. In other words, the locking mechanism is functional throughout a wide range of load conditions because the drive torque due to the threads, thread friction torques 504 and 506, and brake friction torques 502 and 508 are each proportional to the thread normal force.

FIG. 6 is a cutaway view illustrating some internal components of the locking device 104. Illustrated in FIG. 6 is the brake 606 and thrust bearing 608 which are alternate support mechanisms for the threaded rotor 610 which forms an outer portion or chassis of the rotation section 204 of the locking device 104. A shift mechanism 618 includes a rotating thrust driver 602, translating thrust driver 604, rider assembly 614 and control shaft 108 is used to change how axial load through the device is conveyed to the rotating section 204 (e.g., through the thrust bearing 608 or the brake 606). The brake support 616 is a part of the fixed section 202 of the locking device 104 which transmits reaction torque from the brake 606 when the loaded threaded rotor 610 is resting on braking surface 612. The reaction torque passes from the brake 606 to the brake support 616 and into the housing via ridges and keyways as described above.

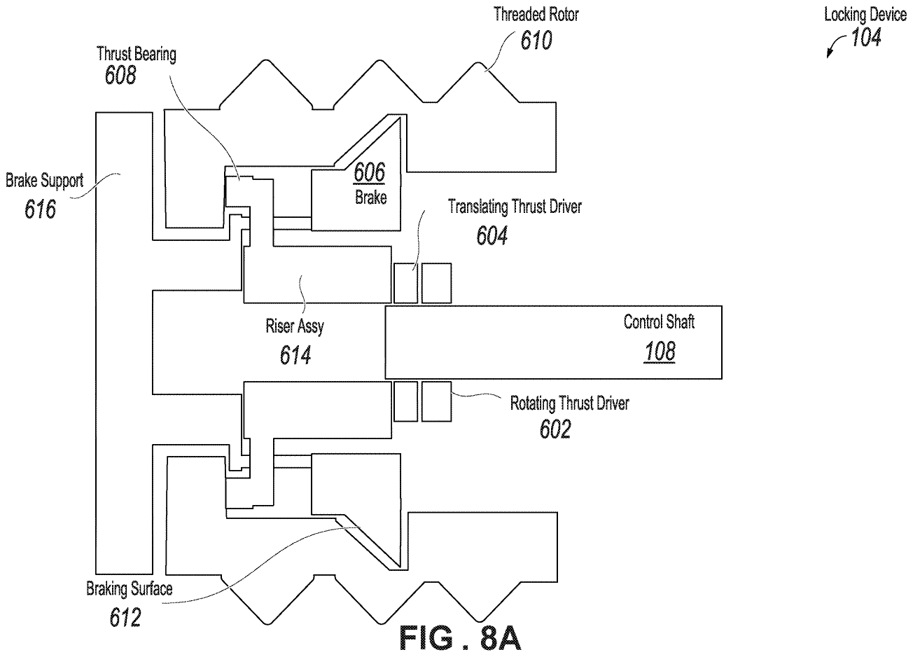

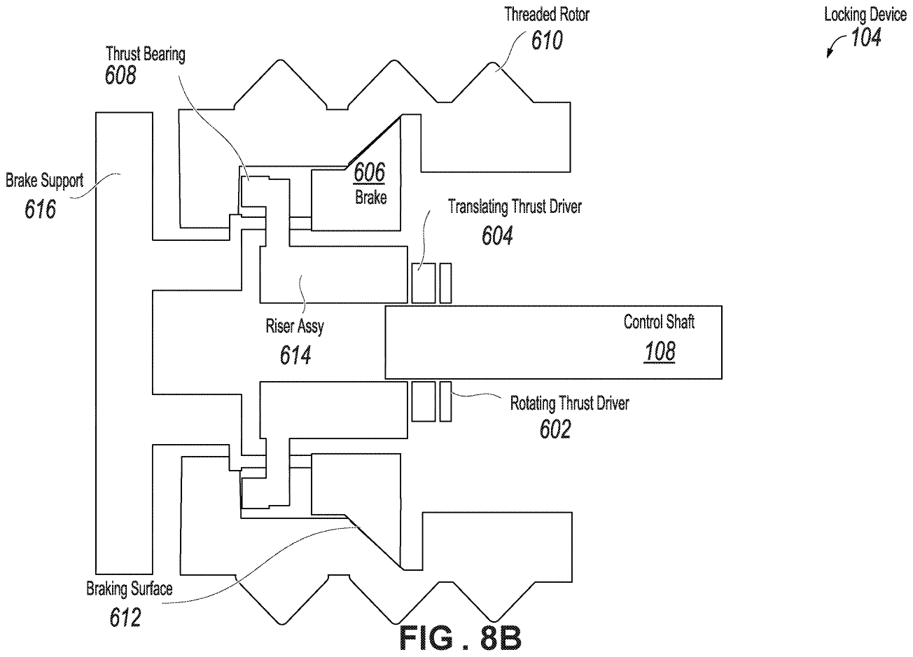

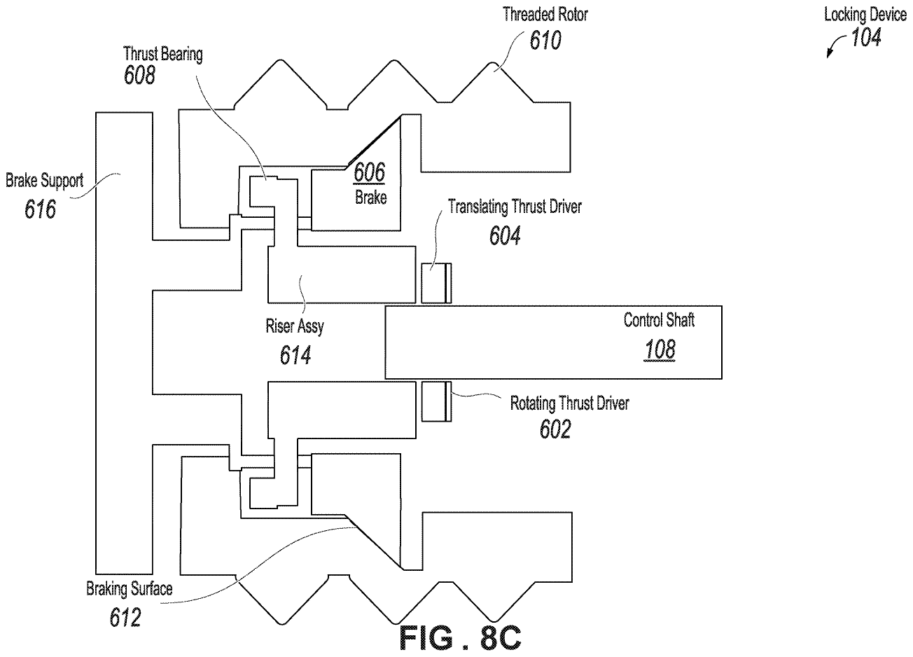

The shift mechanism 618 as illustrated is a relatively small linear actuator that includes a translatable or translating thrust driver 604 and rotating thrust driver 602. When the rotating thrust driver 602 is rotated (e.g., by rotating control shaft 108), the translatable thrust driver 604 is pressed away from the rotating thrust driver 602 in a swashplate-like action causing the riser assembly 614 to move (to the left in the illustrated diagram). The riser assembly 614 applies pressure to the thrust bearing 608, “lifting” the threaded rotor 610 off the brake surface 612. This action is further described below with respect to FIGS. 8A-8C.

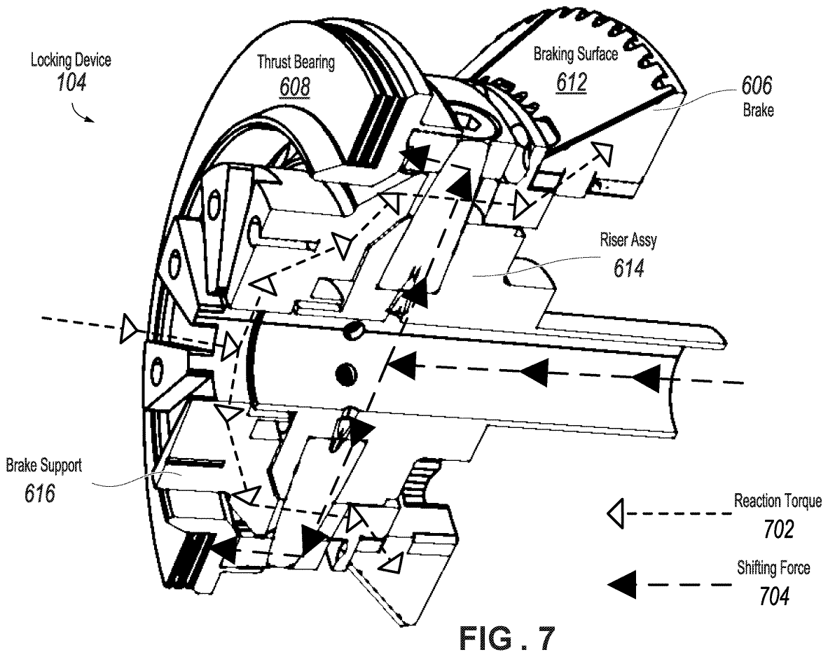

FIG. 7 is a perspective cross-sectional view illustrating force paths within the locking device 104. FIG. 7 shows that the threaded rotor 610 can rest on either the thrust bearing 608, the braking surface 612, or a combination thereof.

When the locking device 104 is in a locked configuration, and the threaded rotor 610 rests primarily on the braking surface 612, the rotational torque induced by the threads upon the application of an external axial force will be at least partially counteracted by a reaction torque 702. That reaction torque 702 is provided from the brake support 616 which is coupled to the fixed section 202 of the device and is keyed into the housing. As shown in FIG. 7, the reaction torque 702 is transmitted from the brake support, past the riser assembly 614 and into the brake 606.

When the device is to be unlocked, and the shifting assembly 618 presses on the riser assembly 614, the shifting force 704 travels up through the riser assembly 614, out through holes in the brake support 616 and into the thrust bearing 608. As the magnitude of the shifting force 704 increases, the tendency for the threaded rotor 610 to back-drive increases until it begins to spin.

It should be noted that the output shaft or the shaft to be locked is affixed to the fixed section 202 (e.g., brake support 616) of the locking device, such that axial load is always transmitted through the fixed section 202 of the device. When the device is in a back-drivable state, the threaded rotor 610 spins freely on the thrust bearing 608, and little force is applied to it.

FIGS. 8A-8C illustrate a simplified schematic diagram showing a shifting operation for the locking device 104. In FIG. 8A, the threaded rotor 610 is resting on the thrust bearing 608, and the device can back-drive. To shift the locking device into a locked condition, the control shaft 108 is rotated, rotating the rotating thrust driver 602 and causing translatable thrust driver 604 to shift the riser assembly 614 to the right in the illustrated example.

In FIG. 8B, the riser assembly 614 has shifted such that the threaded rotor 610 comes into contact with the braking surface 612 of brake 606. FIG. 8B shows an intermediate position where some load is on the thrust bearing 608 and some is on the brake 606. The locking device 104 will shift from being back-drivable to being non-back-drivable while threaded rotor 610 is in contact with both support surfaces as illustrated.

In FIG. 8C, the riser assembly 614 continues to shift, and the thrust bearing 608 comes out of contact with the threaded rotor 610. In FIG. 8C, the threaded rotor is exclusively supported by the brake 606, which offers the greatest assurance that the locking device 104 is no longer back-drivable. However, in some implementations, clearance is not necessarily established between the thrust bearing 608 and the threaded rotor 610 and reliable function can be maintained. Similarly, in some implementations it is not necessary for the shifting force 702 to decrease to zero. Reliable action can occur with finite load still present in the shifting force 702 load path.

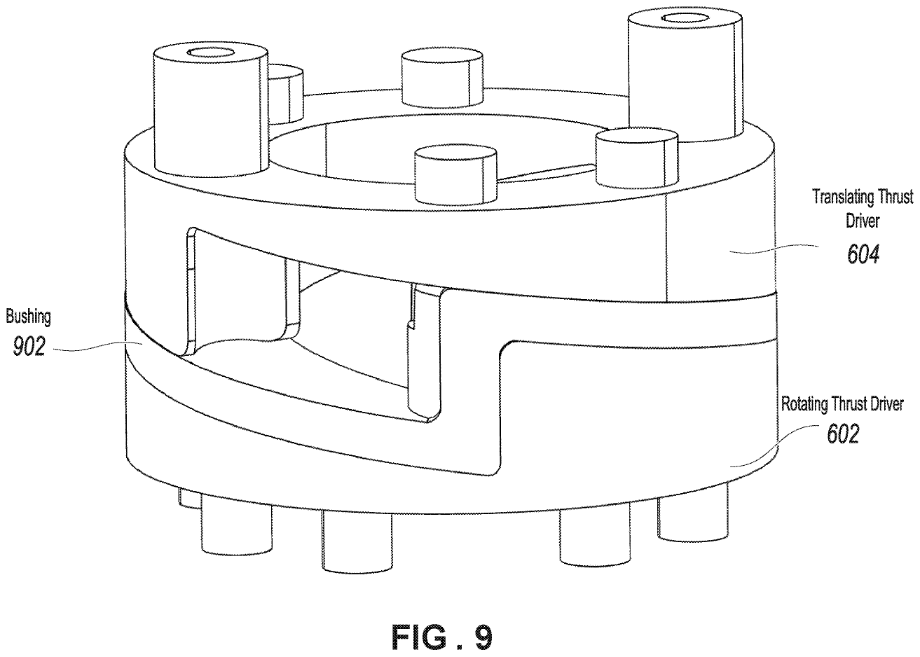

FIG. 9 illustrates an example compact actuator for shifting a locking device. FIG. 9 illustrates the rotating thrust driver 602, and the translatable thrust driver 604 with a bushing 902 between them to improve traveling characteristics. As can be seen in FIG. 9, when the rotating thrust driver 602 is rotated while the translatable thrust driver 604's rotational orientation is fixed, the translatable thrust driver 604 must translate (up or down in the illustrated example). This translation is transferred to the riser assembly 614 to induce shifting of forces in the locking device.

In some implementations, the slope of the contact surface, and material of the bushing 902 is selected such that this shifting actuator is itself back-drivable. That is, under compressive force with no external torque applied to the control shaft 108, the rotating thrust driver 602 will rotate to allow the translatable thrust driver 604 to set back in. The threaded rotor 610 can be spring biased into the braked position, such that if electrical power or external torque to the rotating thrust driver 602 is lost, the actuator will compress, and the locking device will automatically lock. It should be noted that FIG. 9 is provided as an example, and other suitable mechanisms can be used to actuate the locking device 104. For example, a solenoid, spring mechanism, compact hydraulic piston, or other compact actuator can be used instead of the rotatable thrust driver 602 and translatable thrust driver 604 as illustrated.

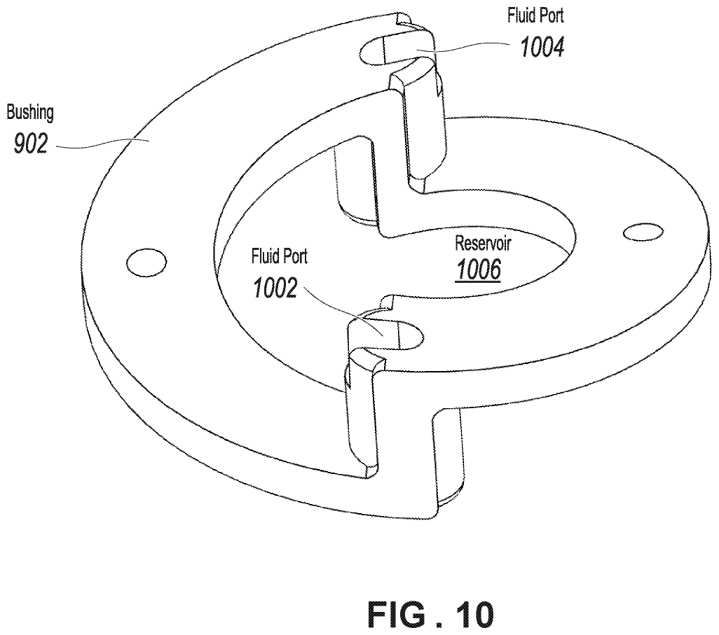

FIG. 10 illustrates a bushing for a compact actuator. In some implementations, the compact actuator is in a sealed environment that has a constant internal volume and is oil filled to reduce friction and component wear. In these implementations, fluid ports 1002 and 1004 can allow oil to transfer between the dynamic volume between the rotating thrust driver 602 and the translatable thrust driver 604 to travel into an adjacent reservoir 1006 as they move relative to one another such that internal oil pressure is maintained relatively constant.

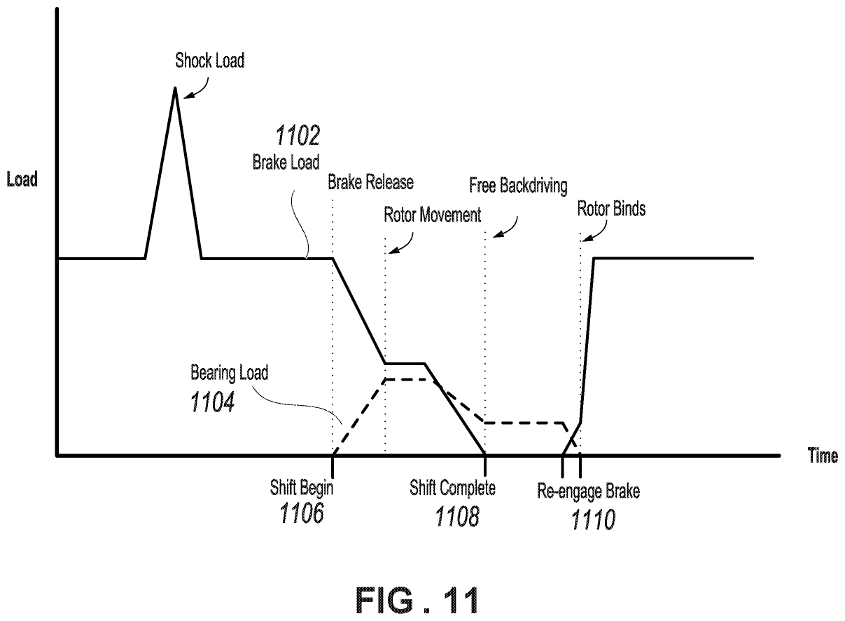

FIG. 11 illustrates a diagram showing locking device load in various conditions. FIG. 11 shows the brake load 1102 which when in the locked configuration can withstand substantial shock loads, in some implementations exceeding the load rating of the actuator mechanism itself. At 1106 when the device is shifted, bearing load 1104 begins to increase while the brake load 1102 concurrently decreases. Eventually as enough load is transferred from the brake onto the bearing, the rotor 610 begins to rotate and becomes back-drivable, and then as load is transferred fully to the bearing and the shift is complete at 1108, the device back-drives under very little load, with the bearing supporting any axial load during free back-driving.

As shown at 1110, if the brake is re-engaged, bearing load decreases as it is disengaged and the brake load increases until the rotor binds, at which point it rapidly increases until it is supporting the entire axial load for the device.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations but is to be accorded the widest scope consistent with the principles and features disclosed herein.

1. A locking device comprising:
a fixed section comprising one or more first mating features configured to engage with one or more second mating features in a housing;
a rotatable section comprising one or more external threads configured to engage with one or more internal threads of the housing; and
a shift mechanism configured to shift axial load across the locking device between a low friction surface and a high friction surface.

2. The locking device of claim 1, wherein the one or more first mating features are ridges or keyways, and wherein the one or more second mating features are keyways or ridges.

3. The locking device of claim 1, wherein when a ratio of axial load supplied to the low friction surface compared to axial load supplied to the high friction surface is greater than a predetermined amount, the locking device is back-drivable along the internal threads, and wherein when the ratio of axial load is below the predetermined amount, the locking device is non-back-drivable along the internal threads.

4. The locking device of claim 1, wherein the rotatable section is configured to rotate about an axis, and wherein the axial load is along the axis.

5. The locking device of claim 1, wherein the high friction surface is a brake, and wherein the low friction surface is supported by a thrust bearing.

6. The locking device of claim 1, wherein the fixed section is rigidly connected to an actuator shaft of a linear actuator.

7. The locking device of claim 6, wherein an actuating mechanism of the linear actuator is configured to act on the fixed section by applying force to the fixed section along an axis defined by the actuator shaft.

8. The locking device of claim 6, wherein an actuating mechanism of the linear actuator is configured to act on the actuator shaft by applying force along an axis defined by the actuator shaft.

9. The locking device of claim 1, wherein the shift mechanism comprises a rotatable thrust driver and a translatable thrust driver that form a thrust driver pair, and wherein the thrust driver pair is configured to elongate when the rotatable thrust driver is rotated.

10. The locking device of claim 9, wherein the rotatable thrust driver and the translatable thrust driver comprise fluid ports configured to permit passage of fluid through the thrust driver pair.

11. The locking device of claim 1, wherein the one or more second mating features comprise three keyways, and wherein the one or more first mating features comprise three ridges.

12. The locking device of claim 1, wherein the external threads comprise multiple leader threads and multiple follower threads, and wherein the follower threads are configured to engage the internal threads of the housing in response to a failure of one or more of the leader threads.

13. The locking device of claim 1, wherein a lead angle of the external threads is at least six degrees.

14. A method for securing a shaft within a housing, the method comprising:
actuating a shift mechanism to cause a transfer of axial load across a locking device affixed to the shaft, the transfer of axial load occurring between a low friction surface and a high friction surface, wherein as the axial load is shifted to the low friction surface from the high friction surface, the locking device becomes back-drivable along internal threads of the housing, and wherein as the axial load is shifted from the low friction surface to the high friction surface the locking device becomes non-back-drivable along the internal threads.

15. The method of claim 14, wherein actuating the shift mechanism comprises rotating a thrust driver to cause a riser assembly to change an internal dimension of the locking device.

16. The method of claim 14, comprising:
back-driving the locking device through the housing when the axial load is applied to the low friction surface.

17. The method of claim 14, wherein the low friction surface is supported by a thrust bearing, and wherein the high friction surface is a brake surface.

18. A linear actuator system comprising:
an actuator shaft coupled to a locking device;
an actuator mechanism configured to transfer force to the actuator shaft to cause the actuator shaft to translate along an axis defined by the actuator shaft;
the locking device comprising:
a rotatable section comprising one or more external threads configured to engage with one or more internal threads of a housing; and
a shift mechanism configured to shift axial load across the locking device between a low friction surface and a high friction surface, wherein when the axial load is applied to the low friction surface, the locking device is back-drivable along the internal threads, and wherein when the axial load is applied to the high friction surface the locking device is non-back-drivable along the internal threads.

19. The system of claim 18, wherein the locking device comprises:
a fixed section comprising one or more ridges configured to engage with one or more keyways in the housing.

20. The system of claim 19, wherein the housing comprises three keyways, and wherein the fixed section comprises three ridges.
